(19) United States
(12) Patent Application Publication
(10) Pub. No.: US 2025/0348925 A1
(43) Pub. Date: Nov. 13, 2025

(54) GENERATIVE MODEL DRIVEN BI-DIRECTIONAL UPDATING OF MULTI-PANE USER INTERFACE

(71) Applicant: GOOGLE LLC, Mountain View, CA (US)

(72) Inventors: Chinmay Kulkarni, Atlanta, GA (US); Gabor Angeli, Cupertino, CA (US); Pavankumar Reddy Muddireddy, Santa Clara, CA (US)

(21) Appl. No.: 19/203,016

(22) Filed: May 8, 2025

Related U.S. Application Data
(60) Provisional application No. 63/645,916, filed on May 12, 2024.

(51) Int. Cl. G06Q 30/0601; G06F 16/3329; G06N 20/00

(52) U.S. Cl. CPC G06Q 30/0643; G06F 16/33295; G06N 20/00

(57) ABSTRACT

Some implementations to a multi-pane graphical user interface (GUI) where, during a dialog session between a user and a generative model system, the generative model system generates first pane responses that are rendered in a first pane of the GUI and generates a second pane response that is rendered in a second pane of the GUI and that is dynamically updated over the dialog session. Further, first pane user inputs, that are directed to the first pane, can cause an additional first pane response to be generated and rendered at the first pane and/or can cause an update to the second pane response. Likewise, second pane user inputs, that are directed to the second pane, can cause a corresponding update to the second pane response and can cause an additional first pane response to be generated and rendered at the first pane.

### BACKGROUND

Various generative models have been proposed that can be used to process natural language (NL) content and/or other input(s) (e.g., image(s) that accompany NL content), to generate output that reflects generative content (e.g., NL content, image(s)) that is responsive to the input(s). For example, large language models (LLM(s)) have been developed that can be used to process NL content and/or other input(s), to generate LLM output that reflects NL content and/or other content that is responsive to the input(s). For instance, an LLM can be used to process NL content of “I want to replace my thermostat with a smart thermostat and my doorbells with smart doorbells by the end of the month”, to generate LLM output. The LLM output can reflect (e.g., via a sequence of probability distributions over a vocabulary), for example, a summary of smart thermostat features, smart doorbell features, and an overview of smart thermostat products and smart doorbell products. The LLM output can be generated, for example, based on intrinsic learned parameters of the LLM itself and/or based on information obtained from one or more external source(s) and processed, along with the NL content and using the LLM, in generating the LLM output.

However, current utilizations of generative models suffer from one or more drawbacks. For example, in the example of the previous paragraph the LLM output can reflect information that is useful to the user and that serves as a good starting point for the user to perform further computer actions directed toward replacing their thermostat and doorbell with smart thermostats and doorbells. For instance, the information can be useful for the user to proactively formulate further inputs to the LLM. However, the user interaction with the LLM is typically solely via a linear dialog sequence in a chat-style interface. This type of linear dialog sequence can be sub-optimal for carrying out many tasks, such as the example task of the previous paragraph. For example, as the dialog progresses, previous dialog turns will disappear off-screen. A user will then have to scroll back through the dialog sequence to view previous responses. For instance, if a user received an LLM response about a particular model of smart thermostat five dialog turns prior, and wants to provide further NL content in a current dialog turn, the user will need to scroll back through the dialog sequence to identify the particular model. This results in extensive utilization of client device resources, such as battery resources of a mobile phone, laptop, or other battery powered client device. In view of these and other considerations, it can be the case that the user is unable to perform such further computer actions without significantly depleting limited battery resources of a client device.

More generally, LLMs and other generative models can be utilized as part of a human to computer dialog, generating responses to inputs/queries provided by a user of the application. However, those dialogs typically occur solely via a linear dialog sequence in a chat-style interface that requires a user to repeatedly formulate natural-language based inputs, often with reference to multiple disparate LLM responses, to progress the dialog over multiple dialog turns.

### SUMMARY

Implementations described herein relate to graphical user interfaces for generative models (GMs). More particularly, implementations disclosed herein relate to a multi-pane graphical user interface (GUI) where, during a dialog session between a user and a generative model system, the generative model system generates first pane responses that are rendered in a first pane of the GUI and generates a second pane response that is rendered in a second pane of the GUI and that is dynamically updated over the dialog session. Further, first pane user inputs, that are directed to the first pane, can cause an additional first pane response to be generated and rendered at the first pane and/or can cause an update to the second pane response. Likewise, second pane user inputs, that are directed to the second pane, can cause a corresponding update to the second pane response and can cause an additional first pane response to be generated and rendered at the first pane.

Accordingly, implementations disclosed herein present a multi-pane GUI where generative model(s) are utilized, during a dialog session, in generating first responses for a first of the multi-panes and are also utilized in generating and dynamically updating a second response for a second of the multi-panes. Further, those implementations enable, during the dialog session, both first pane user inputs to be provided to the first pane and second pane user inputs to be provided to the second pane-any of which can progress the dialog session and result in corresponding response updates to one or both panes. Yet further, some of those implementations seek to provide, via the second pane response, a graphical, structured, and comprehensive representation of the dialog session while also providing, via the first pane responses, a more conversational representation of a current turn of the dialog session. In these and other manners, the bi-directionally updated multi-pane interface enables efficient guiding of a dialog session and can be particularly beneficial in guiding a dialog session related to a complex task such as a task that can have multiple steps, options, or dependencies. Accordingly, implementations present an improved interface that can be more efficiently utilized for complex tasks and that achieves various efficiencies not afforded by dialog sessions that occur solely via a linear dialog sequence in a chat-style interface.

In various implementations, the second pane response includes a plurality of interactive graphical elements that are modifiable through pointing-based interactions that are directed to the interactive graphical elements of the second pane response. Pointing-based interactions can include touch-based inputs (e.g., via touch-sensitive screen(s)), mouse-based inputs, trackpad-based inputs, and/or other pointing-based interactions. For instance, pointing-based interactions can include: tapping or clicking an interactive graphical element to select or deselect the interactive graphical element, multiple taps or clicks directed to a drop-down interactive graphical element to change a selection of the drop-down interactive graphical element from a first state (i.e., specifying the previous selection) to a second state (i.e., specifying the new selection resulting from the multiple taps or clicks); dragging of an interactive element from a first position to a second position in the second pane response to reflect a change in temporal and/or positional state(s) of the interactive element; and/or other interaction(s).

As described herein, a pointing-based interaction with an interactive graphical element of a second pane response can not only update the second pane response accordingly, but it can at least selectively result in generation and rendering of an additional first pane response. The additional first pane response can replace a currently rendered first pane response, or can be presented following the currently rendered first pane response. The additional first pane response can include NL content that can optionally include one or more prompts. The optional prompt(s) can be based on the update to the second pane response and can elicit further input from the user, that is directed to the first pane (e.g., spoken input or a selection of one of the prompts), and that, when provided, can cause a further update to the second pane response. In these and other manners user inputs directed to the second pane can be used to generate additional first pane responses and, further, user inputs directed to the first pane can be used to generate and implement further updates to the second pane response.

Moreover, user input that is directed to the first pane and proactively provided by a user can be processed, using generative model(s) and along with a representation of the second response (as currently updated), to generate update(s) to the second pane response. The second pane response can then be caused to be updated accordingly. In these and other manners, user inputs directed to the first pane can be used to at least selectively update the second pane response.

Various implementations disclosed herein receive an input query that is generated based on user interface input at a client device and utilize generative model(s) to process the input query to generate both a first pane response and a second pane response, where the second pane response includes interactive graphical elements modifiable through pointing-based interaction. Those implementations further cause the first pane response to be rendered in a first pane of a GUI and cause the second pane response to be rendered in a second pane GUI along with and adjacent to the rendering of the first pane response. For example, the first pane response can be rendered in a left pane of the GUI at the same time that the second pane response is also being rendered in a right pane of the GUI. While the GUI is being rendered, implementations can monitor for natural language input directed to the first pane and also monitor for pointing-based input directed to the interactive graphical elements in the second pane. Natural language input directed to the first pane can be used to generate an additional first pane response for rendering in the first pane and/or to generate an update to the second pane response to be implemented for updating the rendering of the second pane response. Moreover, pointing-based input directed to an interactive graphical element in the second pane can be used to update the second pane response and, optionally, to generate an additional first pane response for rendering in the first pane. For example, the additional first pane response can characterize a conflict created by the pointing-based input and, optionally, provide user prompt(s) that suggest resolution(s) to the created conflict.

In some implementations, an LLM or other generative model can include at least hundreds of millions of parameters. In some of those implementations, the LLM or other generative model includes at least billions of parameters, such as one hundred billion or more parameters. In some additional or alternative implementations, an LLM is a sequence-to-sequence model, is Transformer-based, can include an encoder and/or a decoder, can process multi-modal input(s) (e.g., natural language and image(s)), and/or can generate multi-modal output(s). One non-limiting example of an LLM is GOOGLE'S Pathways Language Model (PaLM). Another non-limiting example of an LLM is GOOGLE'S Language Model for Dialog Applications (LaMDA). Another non-limiting example of an LLM is GOOGLE'S multi-modal Gemini model. However, it should be noted that the LLMs described herein are one example of generative machine learning models and are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart that illustrates an example method of implementations disclosed herein

FIG. 2A depicts a flowchart that illustrates an example of block 260 of FIG. 2.

FIG. 2B depicts a flowchart that illustrates an example of block 270 of FIG. 2.

FIG. 2C depicts a flowchart that illustrates an example of block 272 of FIG. 2.

FIG. 3A illustrates: user interface input that forms part of an input query and that is provided in a single pane interface; and a prompt requesting affirmation that dynamic multi-pane interaction is desirable.

FIG. 3B illustrates a multi-pane GUI, with an initial first pane response in a first pane of the GUI and an initial second pane response in a second pane of the GUI.

FIG. 3C illustrates a pointing-based interaction with a graphical interface element of the initial second pane response of FIG. 3B.

FIG. 3D illustrates: the second pane response as updated based on the pointing-based interaction of FIG. 3C; an additional first pane response that is generated based on the pointing-based interaction of FIG. 3C and that includes three resolution portions that present resolutions to a conflict caused by the pointing-based interaction of FIG. 3C; and a pointing-based interaction with one of the resolution portions.

FIG. 3E illustrates the second pane response as further updated based on the pointing-based interaction of FIG. 3D and a further first pane response that is generated based on the pointing-based interaction of FIG. 3D.

FIG. 3F illustrates: natural language input of a user that is directed to the first pane of the GUI; a yet further first pane response that is generated based on the natural language input of FIG. 3F; and a pointing-based interaction with part of the yet further first pane response.

FIG. 3G illustrates the second pane response as yet further updated based on the pointing-based interaction of FIG. 3F and a further first pane response that is generated based on the pointing-based interaction of FIG. 3F.

FIG. 3H illustrates a pointing-based interaction with another graphical interface element of the yet further updated second pane response of FIG. 3G.

FIG. 3I illustrates: the second pane response as even further updated based on the pointing-based interaction of FIG. 3H; an even further first pane response that is generated based on the pointing-based interaction of FIG. 3H.

FIG. 3J illustrates a pointing-based interaction with another graphical interface element of the even further updated second pane response of FIG. 3I.

FIG. 3K illustrates the second pane response as even further updated based on the pointing-based interaction of FIG. 3J.

FIG. 4 depicts an example architecture of a computing device, in accordance with various implementations.

### DETAILED DESCRIPTION

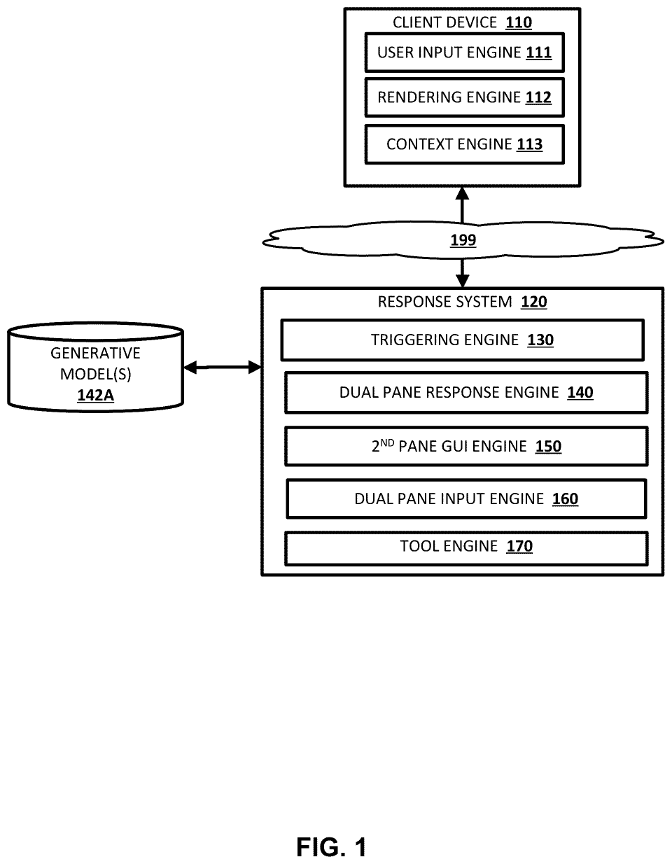

Turning now to FIG. 1, a block diagram of an example environment 100 that demonstrates various aspects of the present disclosure, and in which implementations disclosed herein can be implemented is depicted. The example environment 100 includes a client device 110 and a response system 120. The client device 110 includes a user input engine 111 that can receive spoken, typed, and/or other user interface inputs that can be included as part of an input query provided to the response system 120. The client device 110 also includes a rendering engine 112 that can cause visual rendering of first and second pane responses, single pane responses, user prompt(s), and/or other outputs from response system 120. The client device 110 also includes a context engine 113 that can provide, as part of an input query provided to the response system 120, various local context information such as location, currently executing application(s) at the client device 110, content from currently executing application(s), content from locally stored filed at the client device 110, and/or other context information. Although illustrated separately from client device 110 and coupled with client device via network(s) 199, in some implementations all or aspects of response system 120 can be implemented on the client device 110, optionally as part of a cohesive system with one or more of engines 111, 112, and 113.

In additional or alternative implementations, all or aspects of the response system 120 can be implemented remotely from the client device 110 as depicted in FIG. 1 (e.g., at remote server(s)). In those implementations, the client device 110 and the response system 120 can be communicatively coupled with each other network(s) 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

Further, the client device 110 and/or the response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

Response system 120 is illustrated as including a triggering engine 130, a dual pane response engine 140, a second pane GUI engine 150, a dual pane input engine 160, and tool engine 170. The engines can each interface with one or more generative models 142A, which can be included as part of the response system 120 and/or communicatively coupled with the response system 120 (e.g., accessible via application programming interface(s)). Some of the engines can be omitted in various implementations. In some implementations, the engines of the response system 120 are distributed across one or more computing systems.

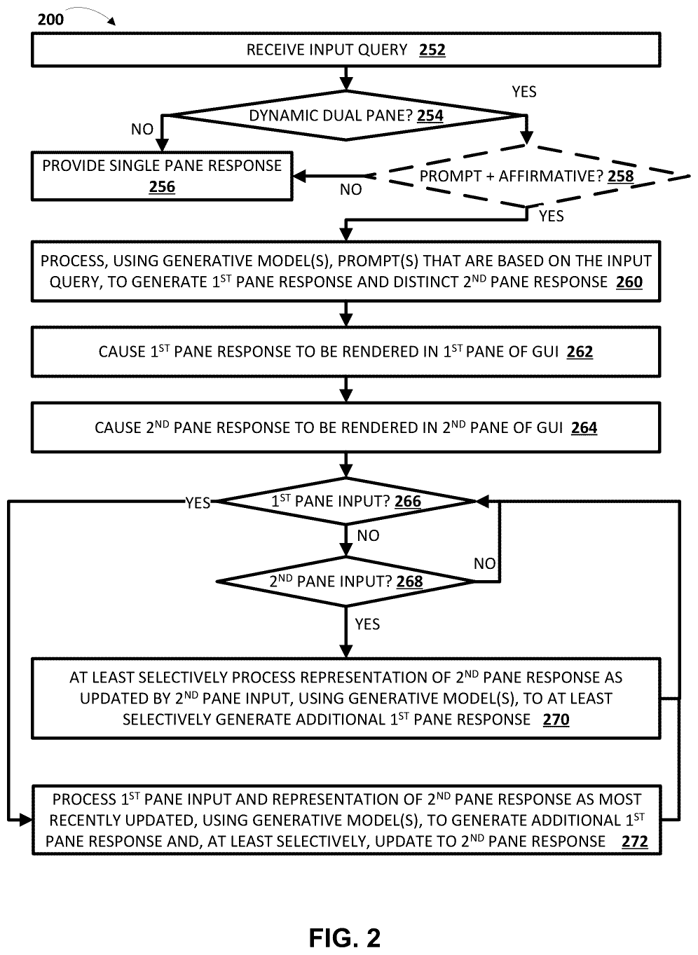

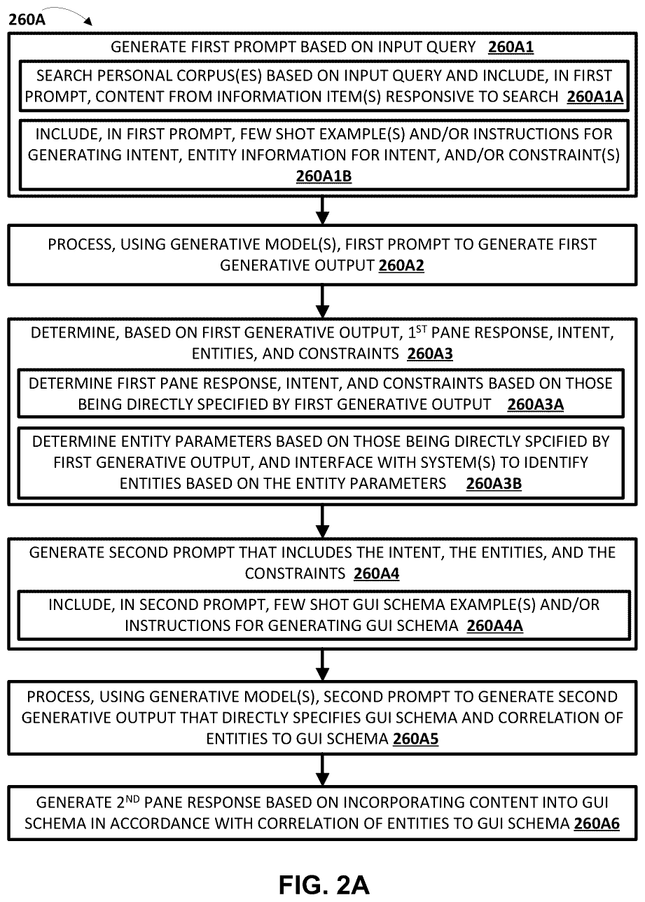

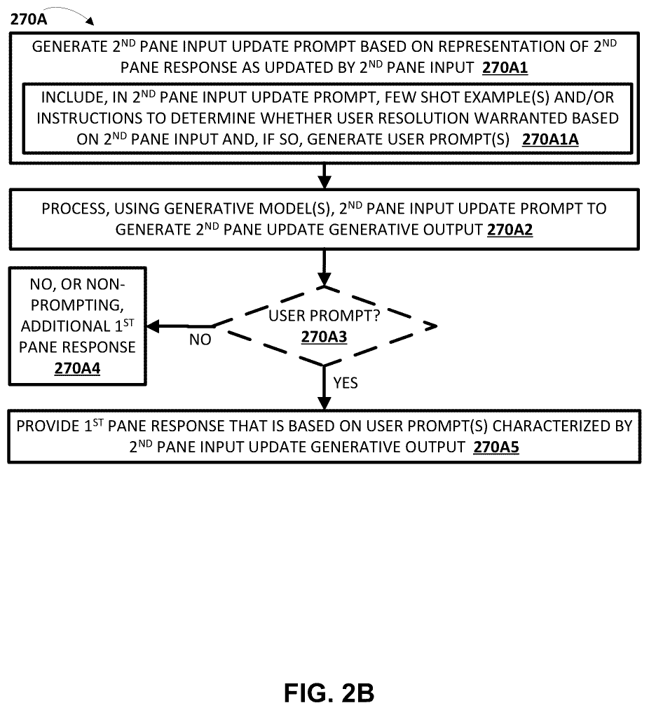

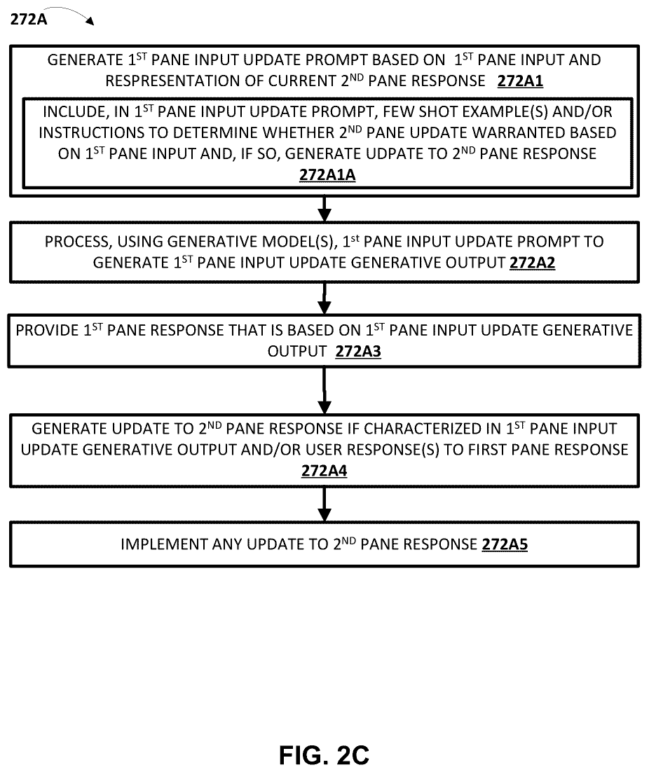

The triggering engine 130 can be configured to determine whether to generate a dynamic dual pane response for a received input query. In some implementations, the triggering engine 130 can perform one or more aspects of block 254 and/or of block 258 of FIG. 2 (described below).

The dual pane response engine 140 can be configured to generate an initial first pane response and second pane response for a dual pane GUI based on an input query and/or can be configured to generate additional first pane responses and/or updates to second pane responses, for a dual pane GUI, based on first pane inputs and/or second pane inputs. In some implementations, the dual pane response engine 140 can perform one or more aspects of block 260, 270, and/or 272 of FIG. 2 (described below), including all or aspects of implementation 260A (FIG. 2A) of block 260, implementations 270A (FIG. 2B) of block 270), and/or implementation 272A of block 272 (FIG. 2C).

The second pane GUI engine 150 can be configured to populate second pane GUI schemas into second pane responses that can be rendered in a second pane of a dual pane GUI. The second pane GUI engine 150 can further be configured to update second pane GUIs in response to pointing-based interaction and/or to update second pane GUIs in response to second pane GUI updates (e.g., generated based on a first pane input). In some implementations, the second pane GUI engine 150 can perform one or more aspects of block 260A6 of FIG. 2A (described below) and/or of implementation 272A5 of FIG. 2C (described below).

The dual pane input engine 160 can be configured to monitor for first pane inputs directed to a first pane of a dual pane GUI and to monitor for second pane input directed to a second pane of a dual pane GUI. In some implementations, the dual pane input engine 160 can perform one or more aspects of blocks 266 and 268 of FIG. 2 (described below).

The tool engine 170 can be configured to interface with one or more external systems (external to response system 120) in identifying entity information, information item(s) from personal corpus(es), and/or other information. In some implementations, the tool engine 170 can perform one or more aspects of block 260A1A and/or block 260A3B of FIG. 2A (described below).

The response system 120 can be configured to generate data for causing graphical rendering of dual pane responses and/or other outputs from response system 120 as described herein. Such data can be provided to (e.g., transmitted via network(s) 199 to) rendering engine 112 and providing such data can cause, directly or indirectly, the rendering engine 112 to perform corresponding rendering.

Turning now to FIG. 2, a flowchart is depicted that illustrates an example method 200 according to implementations disclosed herein. For convenience, the operations of method 200 are described with reference to a system that performs the operations. This system of method 200 includes one or more processors, memory, and/or other component(s) of computing device(s) (e.g., the response system 120 of FIG. 1). Moreover, while operations of method 200 are shown in a particular order, this is not meant to be limiting. One or more operations may be reordered, omitted, and/or added.

At block 252, the system receives an input query. The input query can be one formulated based on user interface input at a client device, such as typed input, voice input, input to cause an image to be captured or selected, etc. In some implementations, when the input includes content that is not in textual format, the system can convert the query to a textual format or other format. For example, if the user interface input is a voice query the system can perform automatic speech recognition (ASR) to convert the voice query into textual format. In some other implementations, when the input includes content that is not in the textual format, the system does not convert such content to a textual format. For example, generative model(s) of further block(s) of FIG. 2 can be multimodal models that can accept multiple modalities of input, including a modality of the content that is not in the textual format.

In some implementations, in addition to including content that is based on user interface input at a client device, the input query of block 252 can include additional content that is based on measured and/or inferred feature(s) of the client device and/or the user. For example, the input query can include additional content that describes a location of the client device and/or additional content that describes explicit or inferred preferences of the user. For instance, the input query can include natural language text, that is provided by the client device along with the content that is based on the user interface input, and that describes a neighborhood, a city, and/or a state in which the client device is located.

At block 254, the system determines whether to provide a dynamic multi-pane GUI responsive to the input query. For example, the input query can be one based on user interface input received via a single pane GUI and the system can determine whether to provide, responsive to the input query: (i) first and second pane responses in a dynamic multi-pane response or, instead, (ii) a single pane response.

In some implementations, in performing block 254 the system processes the input query in determining whether to provide a dynamic multi-pane GUI. For example, the system can process, using one or more LLMs, a prompt that is based on the input query to generate a single pane response. For example, the single pane response can be determined based on LLM output from such processing. The system can further determine, based on the single pane response, whether to provide a dynamic multi-pane GUI. For example, the system can determine whether to provide a dynamic multi-pane GUI based on whether the single pane response includes token(s) indicating a dynamic multi-pane GUI should be provided. For example, the LLM(s), utilized in processing the input query, can be fine-tuned to cause, when an input query is appropriate for comprehensive response generation, generation of LLM output that reflects token(s) that indicate a dynamic multi-pane GUI should be provided. The system can be more likely to (or can always) provide a dynamic multi-pane GUI when the non-comprehensive response includes such token(s).

In some implementations, in performing block 254 the system additionally or alternatively determines whether to provide a dynamic multi-pane GUI based on one or more characteristics of the client device via which user interface input (on which the input query is based) is provided. For example, the system can determine whether to provide a dynamic multi-pane GUI based on a size of a screen of the client device. For instance, the system can determine to provide a dynamic multi-pane GUI only when the size satisfies a threshold. As another example, the system can determine whether to provide a dynamic multi-pane GUI based on a type of the client device (e.g., mobile phone, tablet, desktop, laptop, and/or other type(s)). For instance, the system can determine to provide a dynamic multi-pane GUI only when the client device is a certain type. In some implementations, in performing block 254 the system additionally or alternatively determines whether to provide a dynamic multi-pane GUI based on whether user interface input, at the client device, has explicitly requested such dynamic multi-pane GUI. For example, a GUI button selection, a drop-down menu selection, and/or other selection can explicitly indicate a desire for a such dynamic multi-pane GUI.

If, at block 254, the system determines to not provide the dynamic multi-pane GUI, the system proceeds to block 256 and provides, responsive to the input query, a single pane response and causes the single pane response to be rendered in a single pane GUI at the client device. That is, the system proceeds to block 256 and causes the single pane response to be rendered at the client device responsive to the input query, and without performing one or more further blocks of method 200. In some implementations, the single pane response is one generated in performing block 254. A single pane response for an input query, in addition to being rendered in only a single pane as opposed to in two panes, includes differing content than does the combination of a first pane response and a second pane response to the input query. For example, the single pane response can be one generated based on processing the input query utilizing an LLM and without any processing, utilizing the LLM and along with the input query, of content that is processed in generating a second pane response-such as GUI schema example(s), entities, and/or constraint(s). In some implementations, a single pane response is one generated utilizing only a single pass of a single LLM and a first response and a second response, of a multi-pane response, are generated in at least two passes of one or more LLMs.

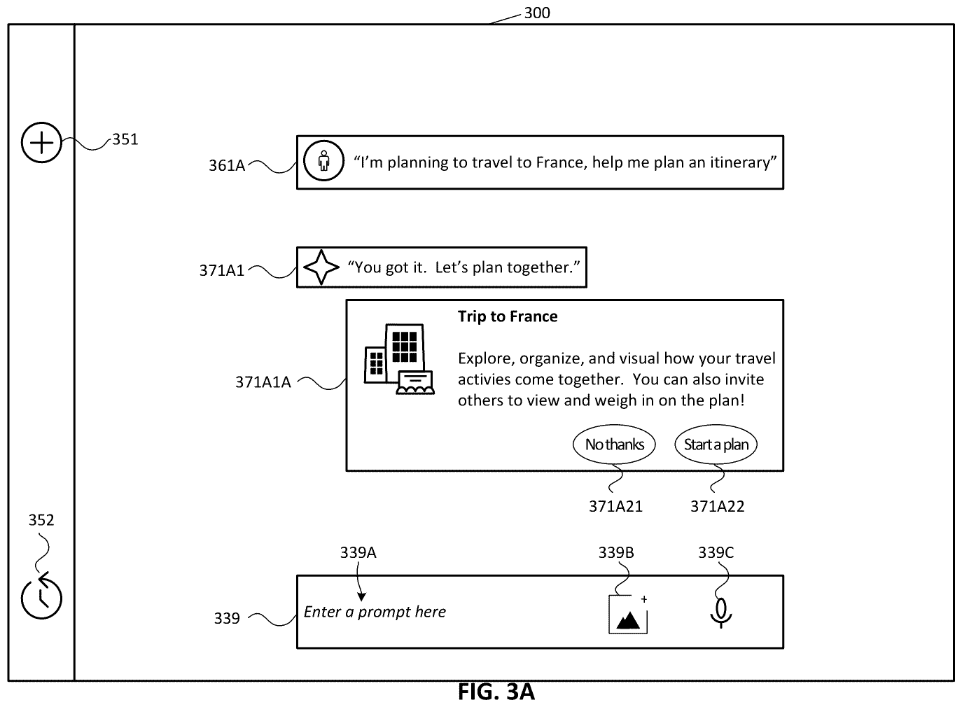

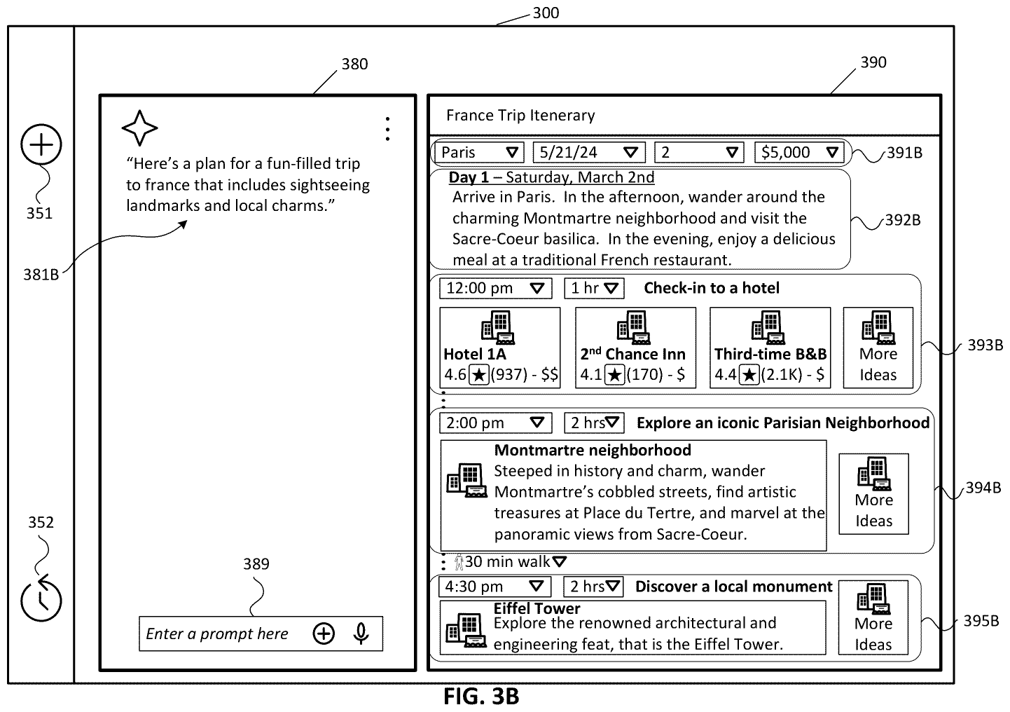

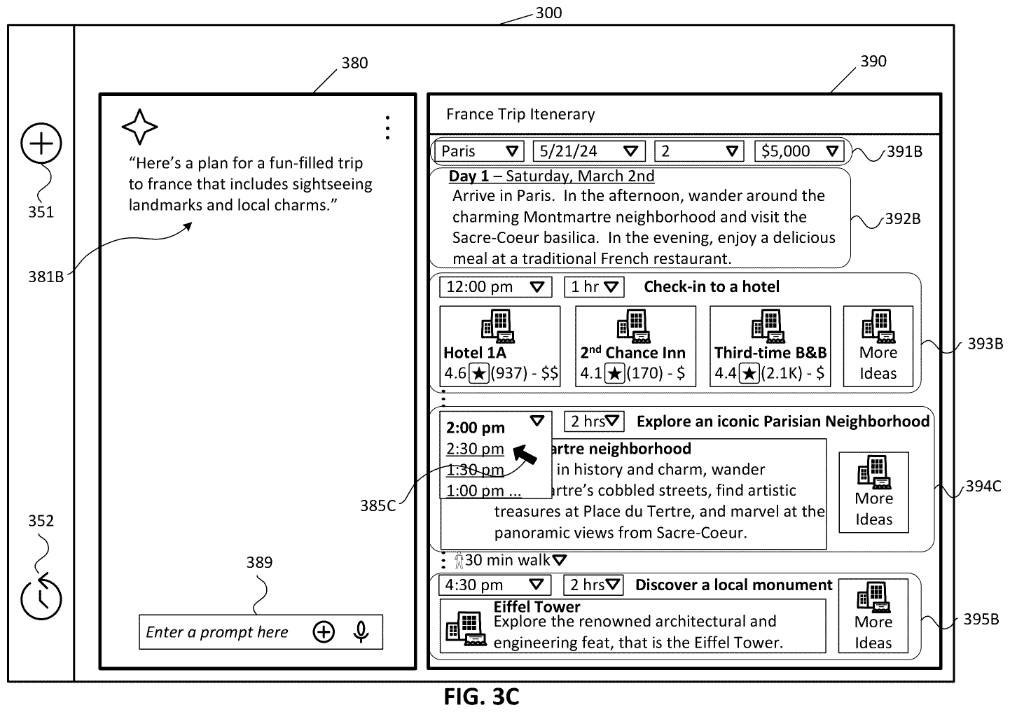

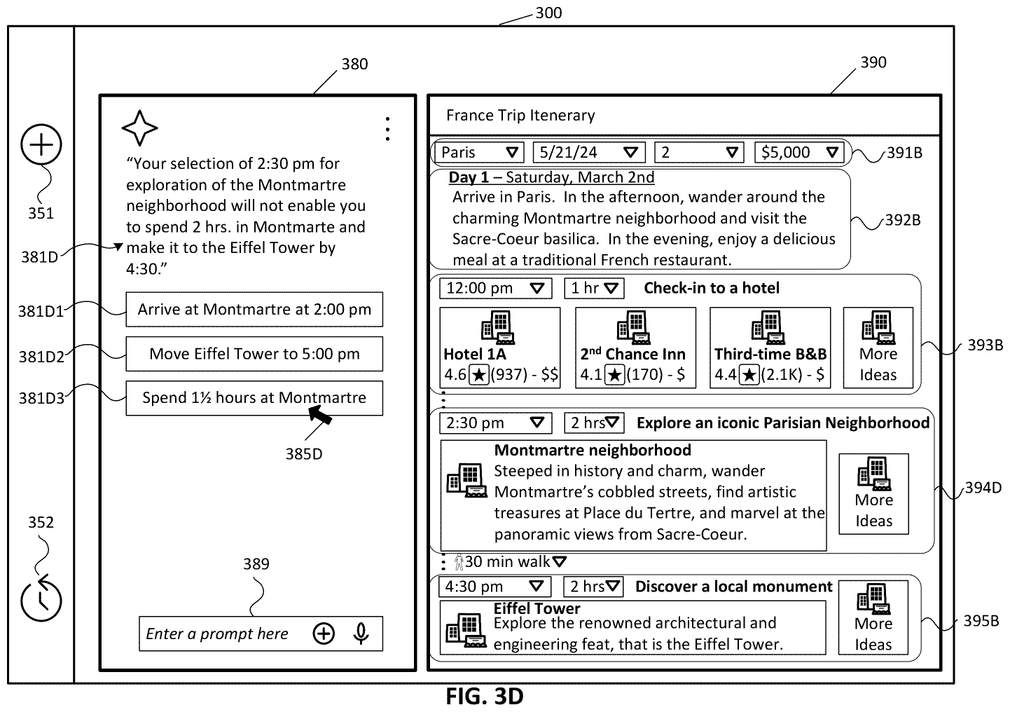

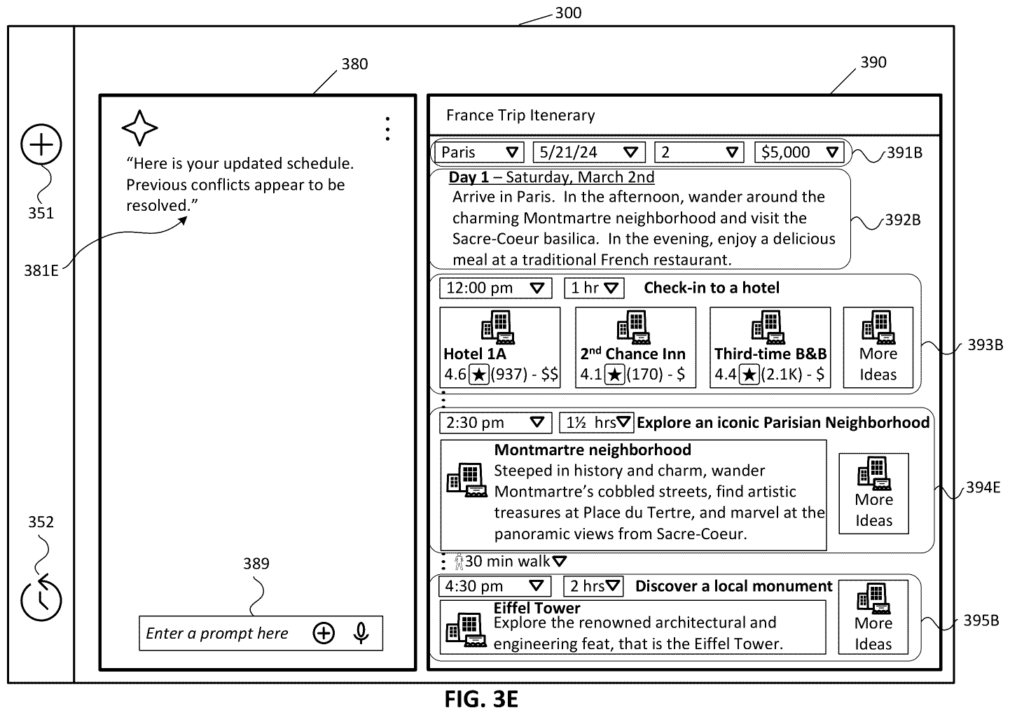

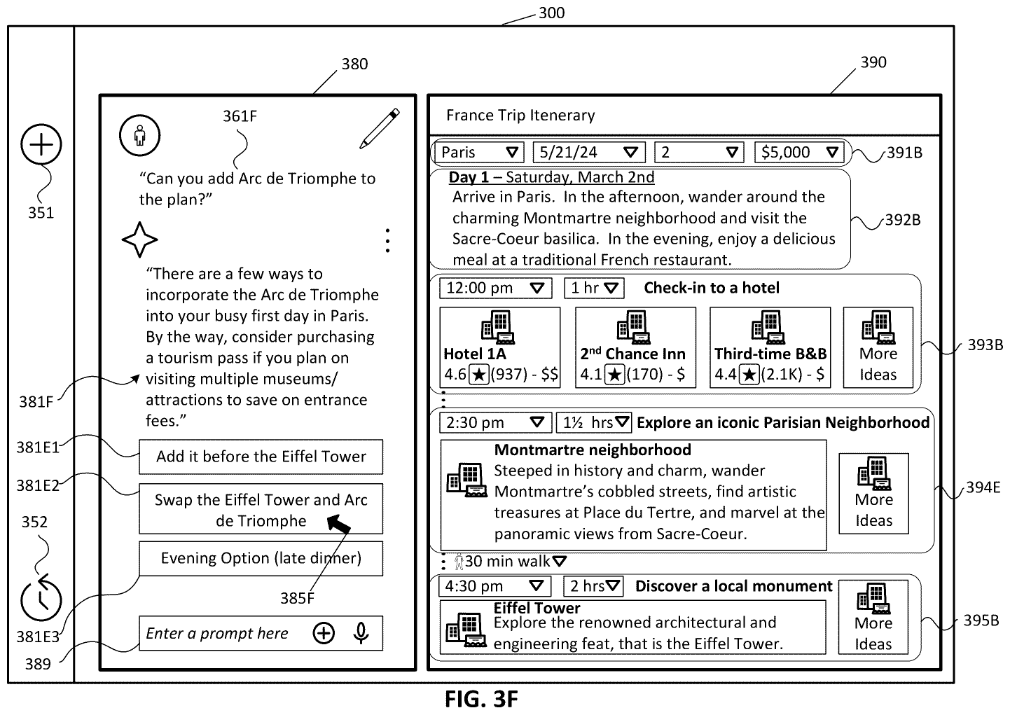

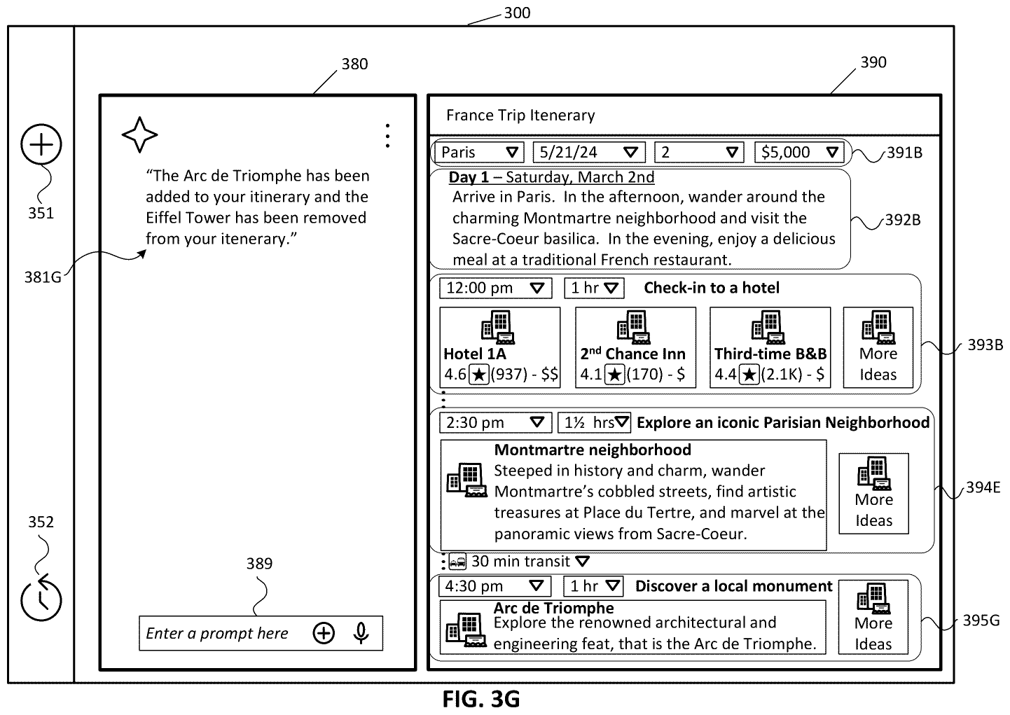

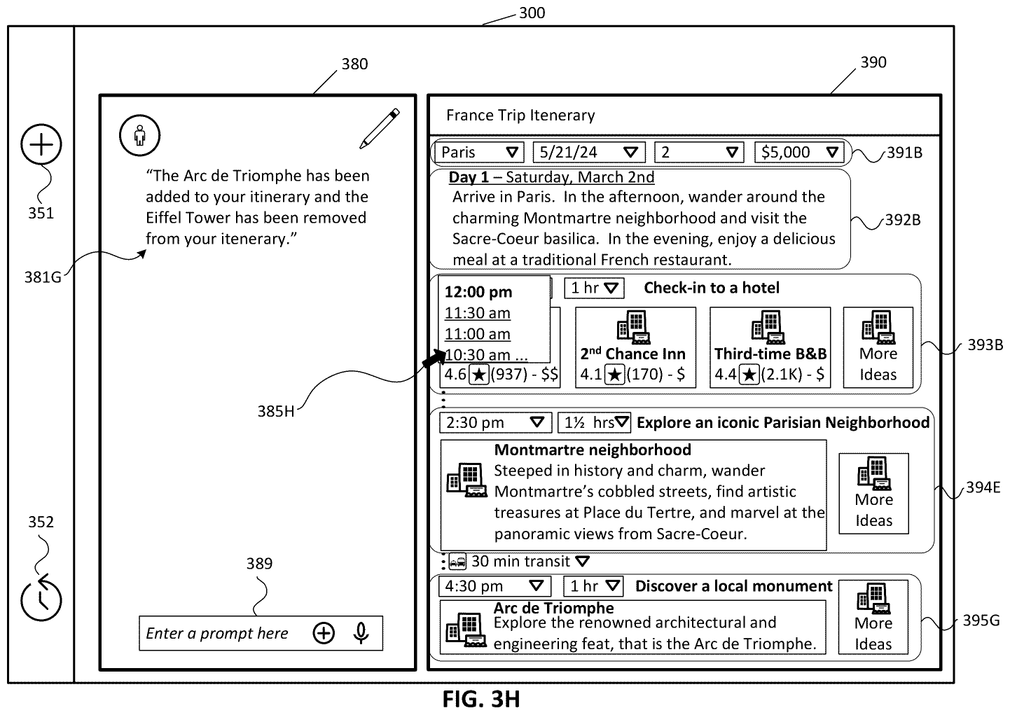

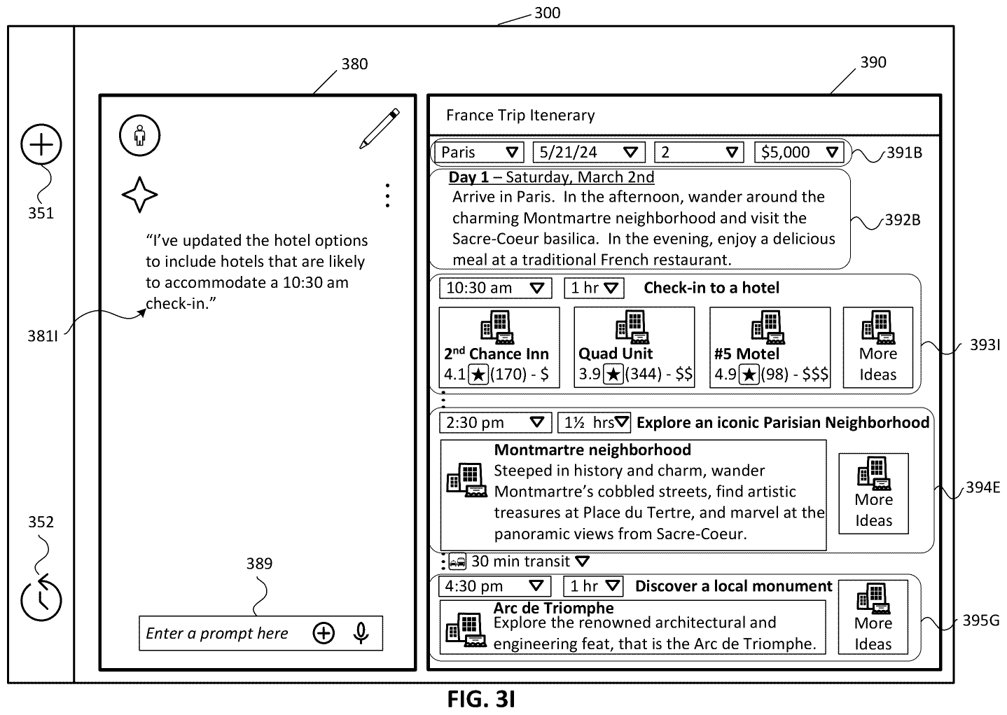

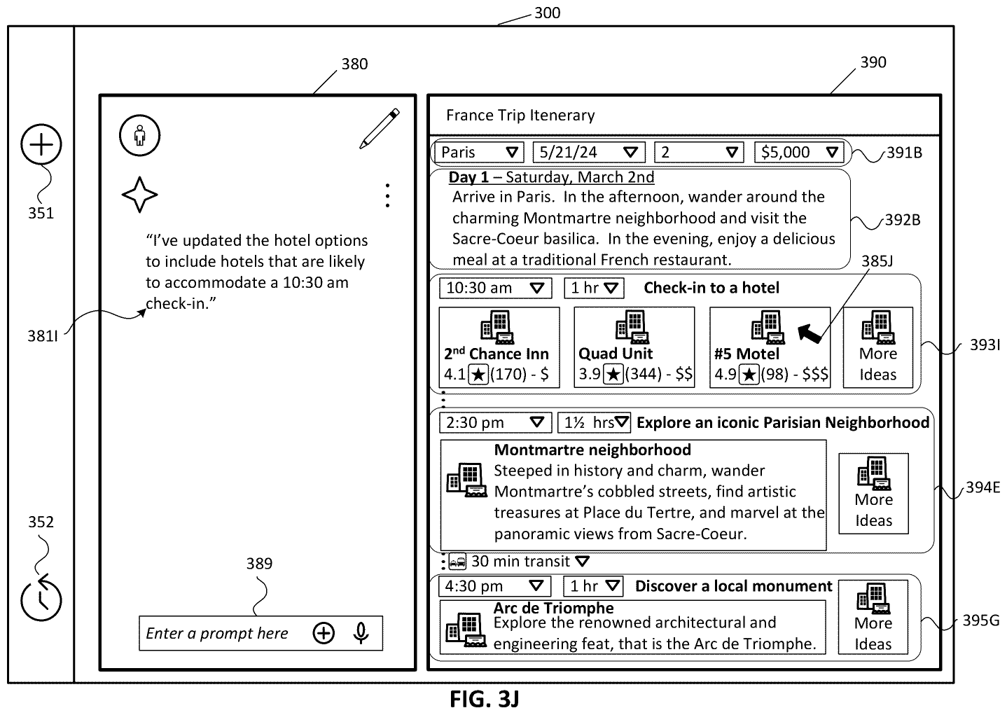

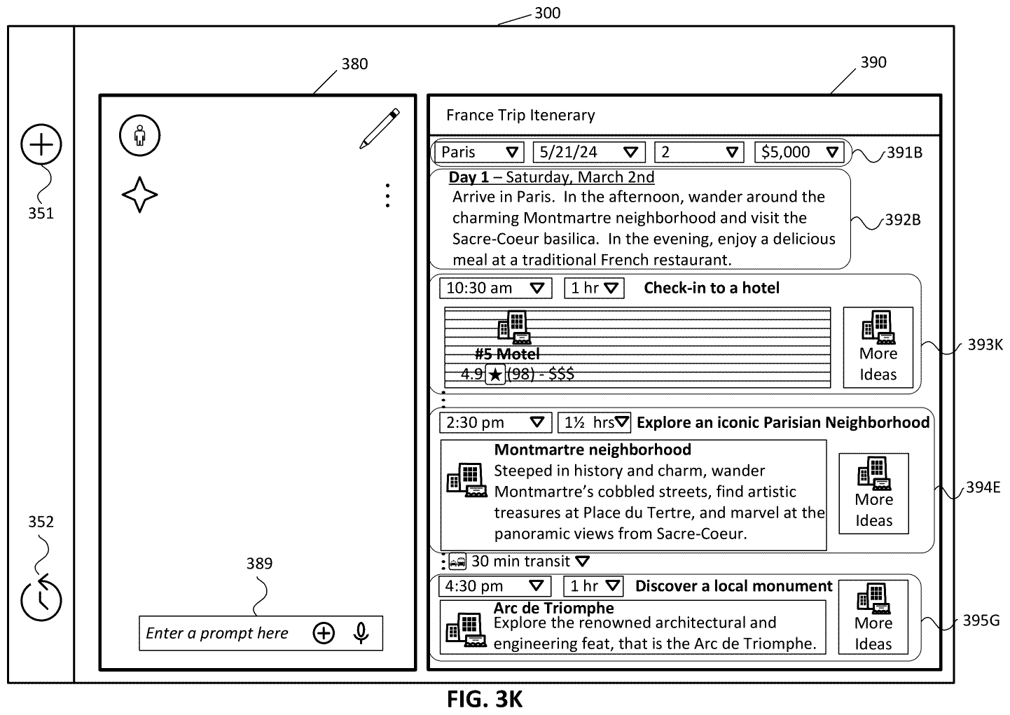

If, at block 254, the system determines to provide the dynamic multi-pane GUI, the system proceeds to block 260. In some implementations, prior to proceeding to block 260, the system first proceeds to block 258 and causes a prompt to be rendered (at the client device via which the user interface input is received) and determines whether affirmative user interface input is received responsive to the prompt. If so, the system proceeds to block 260. If not, the system proceeds to block 256. The prompt can be one that requests affirmation that dynamic multi-pane interaction is desirable. FIG. 3A (described below) illustrates a non-limiting example of such a prompt.

Accordingly, block 256 is performed for at least some input queries when it is determined, based on one or more objective criteria, that a single pane response should be provided in lieu of a comprehensive response. In these and other manners, single pane responses, which can be generated with greater computational efficiency and less latency relative to generation of first and second pane responses, are at least selectively provided. However, according to method 200 and as described herein, first and second pane responses are generated and provided in a multi-pane GUI for at least some input queries. Further, such first and second pane responses, while requiring more computational resources and increased latency to generate relative to their single pane counterparts, can achieve various efficiencies as described herein and can enable new input modalities and/or guiding of a dialog session.

At block 260, the system processes, using one or more generative models, prompt(s), that are based on the input query, to generate a first pane response and a distinct second pane response. In some implementations, block 260 can include one or more aspects of the implementation 260A, of block 260, that is illustrated in FIG. 2A (described below).

At block 262, the system causes the first pane response to be rendered in a first pane of a GUI. For example, the system can transmit the first pane response along with instructions to render it in the first pane.

At block 264, the system causes the second pane response to be rendered in a second pane of a GUI. For example, the system can transmit the second pane response along with instructions to render it in the second pane.

The first pane response and the second pane response are caused to be rendered along with one another. For example, even though the first pane response may be rendered before (e.g., milliseconds or second(s) before) the second pane response, the duration of rendering of first pane response overlaps with a duration of rendering of the second pane response.

In some implementations, the first pane response is generated before the second pane response and is caused to be rendered in response to its generation, thereby causing the first pane response to be rendered before the second pane response. In these and other manners a user can begin reviewing the first pane response prior to the second pane response being provided.

In some implementations, the first pane is positioned to the left in the GUI and the second pane is positioned to the right in the GUI. In some of those or other implementations the first pane occupies a lesser area of the GUI than does the second pane. For example, the first pane can occupy less than 75%, 60%, 50%, or other percent of the area occupied by the second pane.

Through iterations of block 266 and 268, the system simultaneously monitors for first pane input that is directed to the first pane (through iterations of block 266) and for second pane input that is directed to the second pane (through iterations of block 268). The first pane input can include natural language input and, optionally, pointing-based input and/or image-based input (e.g., an uploaded image). In some implementations, input can be determined to be first pane input that is directed to the first pane based on it being natural language input. In some of those implementations, second pane input excludes natural language input (e.g., is restricted to pointing-based input that is directed to interactive element(s) of the second pane response). In some implementations, input can be determined to be first pane input that is directed to the first pane based on it being provided following interaction with an input interface element rendered in the first pane (e.g., input interface element 389 of FIGS. 3B-3K). In some implementations, input can be determined to be second pane input that is directed to the second pane based on it being pointing-based input that is directed at (e.g., atop of) an interactive graphical element of the second pane response being rendered in the second pane.

If first pane input is detected at an iteration of block 266, the system proceeds to block 272. At block 272, the system processes the detected first pane input and a representation of the current second pane response, using one or more generative models, to at least selectively generate an additional first pane response and at least selectively generate an update to the second pane response. The system can then cause the additional first pane response to be rendered in the first pane of the GUI. When an update to the second pane response is generated, the system can also cause the update to the second pane response to be implemented, thereby updating the current second pane response to an updated second pane response. In some implementations, block 272 can include one or more aspects of the implementation 272A, of block 272, that is illustrated in FIG. 2C (described below).

If second pane input is detected at an iteration of block 268, the system proceeds to block 270. At block 270, the system at least selectively processes the first pane input, a representation of the second pane response, as updated by the detected second pane input, using one or more generative models to at least selectively generate an additional first pane response. The system can then cause the additional first pane response to be rendered in the first pane of the GUI. For example, the additional first pane response can supplant, in the first pane, any currently rendered first pane response or can be rendered following (e.g., below) any currently rendered first pane response, optionally scrolling up all or parts of the first pane response so that they are hidden in the first pane of the GUI but accessible via interaction with the first pane of the GUI. In some implementations, block 270 can include one or more aspects of the implementation 270A, of block 270, that is illustrated in FIG. 2B (described below).

FIG. 2A depicts a flowchart that illustrates an example implementation 260A of block 260 of FIG. 2.

At block 260A1, the system generates a first prompt based on the input query. Block 260A1 optionally includes sub-block 260A1A and/or sub-block 260A1B.

At sub-block 260A1A, the system searches one or more personal corpuses based on the input query and includes, in the prompt, content from information item(s) that are responsive to the search. For example, account information for the user can be included with or in association with user interface input on which the input query is based. That account information, with permission from the user, can be used to identify personal corpus(es), such as an email corpus and/or a documents corpus. Further, keyword(s) from the input query can be used to search those corpuses to identify responsive information items and content from (e.g., all or portions of text of) those information items included in the first prompt.

At sub-block 260A1B, the system includes, in the first prompt one or more few shot examples and/or instructions. The few shot examples can include, for example, example input queries and, for each example input query, a corresponding entity, corresponding entity information, and corresponding constraint(s). The instructions can include instructions to generate, based on the input query, intent(s), entity information for the intent(s), and/or constraint(s) for the intent(s). For example, the instructions can be of the form “given [first prompt] output a concise response to provide and also output intent(s) indicated by [first prompt], any constraints for the [intent] that are specified by the [first prompt], and entity parameters for entities that are needed to accomplish [intent]”.

At block 260A2, the system processes, using generative model(s), the first prompt to generate first generative output. For example, the generative model(s) can include LLM(s) optionally fine-tuned based on training data for generating, based on input queries, corresponding first pane responses, intent(s), entity information for the intent(s), and constraints for the intent(s).

At block 260A3, the system determines, based on the first generative output, a first pane response, intent(s) reflected by the first prompt, entity information for the intent(s), and/or constraint(s) for the intent(s). For example, if the input query is “help me plan a trip to Paris from July 18^{th} to July 24^{th}” the first pane response could be “Here's an initial plan for a trip to France”, the intent(s) can include “plan a trip”, the constraint(s) can include date constraints of “departing on July 18^{th} and returning on July 24^{th}” and a location constraint of Paris, France, and the entity information can include details (e.g., names, locations, prices, ratings, etc.) for multiple hotels, for multiple flight options, for multiple restaurant options, for multiple sightseeing options, etc.

In some implementations, block 260A3 includes sub-blocks 260A3A and 260A3B. At sub-block 260A3A, the system determines the first pane response, the intent, and the constraints based on those being directly specified by the first generative output. Optionally, some or all of the entities can also be directly specified by the first generative output. For example, popular sightseeing destinations can be specified by the first generative output.

At sub-block 260A3B, the system determines entity parameters based on those being directly specified by the first generative output, and interfaces with one or more system to identify entities based on those entity parameters. For example, entity parameters can include those for flight entities, such as departing airport, arrival airport, departing date, and arrival date—and the system can interface with flight system(s) (e.g., via application programming interface(s) (API(s)) to identify flight entities (each being a different flight option and including details for the flight option) based on those parameters. As another example, entity parameters can include those for hotel entities, such as location, arrival date, and departing date—and the system can interface with hotel system(s) (e.g., via application programming interface(s) (API(s)) to identify hotel entities (each being a different flight option and including details for the flight option) based on those parameters.

At block 260A4, the system generates a second prompt that includes the intent, the entities, and the constraints. Block 260A4 optionally includes sub-block 260A4A in which the system includes, in the second prompt, few shot second pane GUI schema examples and/or instructions for generating a second pane GUI schema. A second pane GUI schema can define an outline or a shell of a second pane GUI, including types of interface elements that should be included in the second pane GUI (including interactive interface element(s) of the second pane GUI), positions of the interface element(s) in the second pane GUI, types of interactions that should be allowed in the second pane GUI (e.g., can interface element(s) be dragged in the GUI). Put another way, a second pane GUI schema can define a skeleton for a second pane GUI, but content will need to be integrated into the skeleton to have a complete second pane GUI. The instructions for generating the second pane GUI schema can be of the form “given [intent, entities, constraints] generate a GUI schema that defines a shell for the GUI and that specifies a subset of the [entities] and that correlates entities of the subset with where they should be incorporated in the shell when the shell is populated; use few shot second pane GUI schema examples, but generated GUI schema can differ from the few shot examples”.

At block 260A5, the system processes, using generative model(s), the second prompt to generate second generative output that directly specifies the GUI schema and a correlation of entities to the GUI schema. The generative model(s) utilized at block 260A5 can be the same as, or different than, those used in block 260A2. For example, those used in block 260A2 can be fine-tuned in a different manner than those used in block 260A5. As another example, the generative mode used in block 260A5 can have a larger context window than the generative model used in block 260A1.

At block 260A6, the system generates the second pane response based on incorporating content into the GUI schema that is specified by the second generative output. The system can incorporate the content into the GUI schema in accordance with the correlation of entities, to the GUI schema, which is also specified by the second generative output. For example, the GUI schema can include a “check-in to hotel” section that includes placeholders for three hotels and, for each of those hotels, a name, an image, a review rating, and a price. Further, the correlation of the entities, to the GUI schema, can include an indication of three particular hotels that should be populated in those placeholders. The system can populate content for each of those hotels based on the GUI schema and the correlation. For example, the system can identify a name, an image, a review rating, and a price for each of the hotels and cause that information to be integrated in the placeholders.

FIG. 2B depicts a flowchart that illustrates an example implementation 270A of block 270 of FIG. 2.

At block 270A1, the system generates a second pane input update prompt based on a representation of the second pane response as updated by the detected second pane input. For example, the system can generate the second pane input update prompt to include a representation of the second pane response, as it was prior to the detected second pane input, as well as a description of the detected second pane input. The representation of the second pane response can include, for example, description of rendered graphical elements (e.g., their contents and/or relative positions), description of local constraint(s) for rendered graphical elements, and/or description of global constraints for an intent of the input query.

Block 270A1 optionally includes sub-block 270A1A in which the system includes, in the second pane input update prompt, one or more few shot examples and/or instructions. The instructions can be instructions to determine whether resolution is warranted based on the detected second pane input and, if so, to generate user prompt(s) to facilitate the resolution. For example, the instructions can be of the form “given [2^{nd} pane response] and [2^{nd} pane input] output ‘no prompt’ if no conflicts are caused by the [2^{nd} pane input]; otherwise, describe the conflict(s) and present user prompt(s) that, if answered, would resolve the conflict(s)”. The few shot example(s), when provided in the second pane input prompt, can, for example, each include an example of a detected conflict and user prompt(s) for resolving the conflict.

At block 270A2, the system processes, using generative model(s), the second pane input update prompt to generate second pane update generative output.

At block 270A3, the system determines, based on the second pane update generative output, whether to provide, responsive to the detected second pane input, a user prompt that includes a resolution portion for facilitating resolution of conflict(s) caused by the detected second pane input. For example, if the second pane input update prompt includes instructions to output “no prompt” if no conflicts are caused by the detected second pane input, then at block 270A3 the system can determine not to provide a user prompt if the second pane update generative output includes “no prompt” or other “no prompt” token(s). As another example, if the second pane update generative output characterizes a user prompt, then at block 270A3 the system can determine to provide the characterized user prompt.

If, at block 270A3, the system determines to not provide a user prompt that includes a resolution portion, the system proceeds to block 270A4 and the system does not provide any additional first pane response or, alternatively, provides an additional first pane response that is a non-prompting response. A non-prompting response can lack any explicit prompt and, rather, can merely be descriptive of the detected second pane input. FIG. 3K (described below) illustrates an example where no additional first pane response is provided based on a second pane input (385J of FIG. 3J).

If, at block 270A3, the system determines to provide a user prompt that includes a resolution portion, the system proceeds to block 270A5. At block 270A5, the system provides a first pane response that is based on user prompt(s) characterized by the second pane update generative output of block 270A2. FIG. 3D (described below) illustrates an example where, based on second pane input (385C of FIG. 3C), a first pane response (381D) is provided that includes user prompts (381D1, 381D2, 381D3).

If, responsive to the first pane response that is based on user prompt(s) of block 270A5, a user response is received that is directed to the first pane, it will be detected as a first pane input and processed according to block 272 (FIG. 2). For example, an iteration of block 272 can be performed to determine, based on the user response, an update to make to the second response portion.

FIG. 2C depicts a flowchart that illustrates an example of block 272 of FIG. 2.

At block 272A1, the system generates a first pane input update prompt based on a first pane input and a representation of a current second pane response.

Block 272A1 optionally includes sub-block 272A1A in which the system includes, in the first pane input update prompt, few shot example(s) and/or instructions. The instructions can be instructions to determine whether a second pane update is warranted based on the first pane input and, if so, to generate an update to the second pane response. The few shot example(s) can include examples of first pane inputs and representations of a current second pane responses and whether second pane updates were warranted and, if so, update(s) that were warranted.

At block 272A2, the system processes, using generative model(s), the first pane input update prompt (generated at block 272A1), to generate a first pane input update generative output.

At block 272A3, the system provides a first pane response that is based on the first pane input update generative output of block 272A2. For example, the system can cause the first pane response to be rendered in the first pane.

At block 272A4, the system generates an update to the second pane response if any update to the second pane response is characterized in the first pane input update generative output of block 272A2 and/or is characterized in user response(s) to the first pane response provided at block 272A3.

At block 272A5, the system implements any update, to the second pane response, if any is generated at block 272A4. For example, the system can cause the update to be provided for implementation in the second pane.

Turning now to FIGS. 3A through 3K an example GUI 300 is illustrated that can be rendered via a display of a client device. Further, FIGS. 3A through 3K illustrate a non-limiting example of a sequence of GUI updates that can be provided in response to a sequence of user inputs to a GUI for interfacing with a generative model.

FIG. 3A illustrates an example user interface input 361A that forms at least part of an input query and that is provided in a single pane interface of the GUI 300. The user interface input 361A can be an input provided through interaction with an input interface element 339. For example, user interaction with area 339A (e.g., tapping/clicking) can enable typed input to be provided, user interaction with icon 339B can enable image(s) to be uploaded by the user (optionally along with typed or spoken input), and user interaction with icon 339C can enable spoken input to be provided (which can be converted to text using speech recognition and before further processing).

FIG. 3A further illustrates an example of an initial response 371A1 that can be provided, responsive to the user interface input 361A, where the initial response 371A1 includes a prompt 371A1A causes a prompt to be rendered that requests affirmation that dynamic multi-pane interaction is desirable. If non-affirmative user interface element 371A21 is selected, a single pane response can be provided without providing any multi-pane GUI and first and second responses in the multi-pane GUI. However, if affirmative user interface element 371A21 is selected, it can be determined that a multi-pane GUI and first and second responses should be rendered. For example, the system can progress to FIG. 3B in response to detecting a selection of affirmative user interface element 371A21.

FIG. 3B illustrates the GUI 300 being updated to display a multi-pane GUI, as do FIGS. 3C-3K. The multi-pane GUI includes a first pane 380 and a second pane 390. In FIG. 3B, an initial first pane response 381B is rendered in the first pane 390 an initial second pane response is rendered in the second pane 390 of the GUI. The initial second pane response includes elements 391B that include interactive elements reflecting global constraints determined based on the initial input query. The drop-downs of the elements 391B can be interacted with, through pointing-based input, to define alternate global constraint(s).

The initial second pane response also includes sections 393B, 394B, and 395B, each of which contain multiple interactive graphical elements. For example, in section 393B the time (12:00 pm) element is an interactive graphical element to enable defining of alternate times, as is the duration (1 hr) element. Further, the three displayed hotel icons are each an interactive graphical element in that any one of them can be selected, through pointing-based input, to indicate that it is a currently selected hotel.

FIG. 3B, and FIGS. 3C-3K, include an input interface element 339, an additional window element 351, and a history element 352. The input interface element 339 can be interacted with to enable a user to provide natural language input directed to the first pane 380. For example, like interface element 339 of FIG. 3A, an area of it can be interacted with to enable providing typed input, the “+” icon can be interacted with to enable providing image or other media content, and the “microphone” icon can be interacted with to enable providing spoken input. The additional window element 351 can, when selected, open a new multi-pane interface via which a user can provide a new natural language input to a first pane of the multi-pane interface. The history element 352 can be selected to enable reverting back to prior states of the multi-pane GUI—to effectively undo first pane inputs and/or second pane inputs.

FIG. 3C illustrates a pointing-based interaction 385C with a time interactive graphical element of section 394C to select an alternate local time constraint of “2:30” in lieu of the initial “2:00” local time constraint of the initial second response. Accordingly, the pointing-based interaction 385C updates the state of the time interactive graphical element of section 394B from “2:00” to “2:30” as illustrated in FIG. 3D by updated section 394C.

In response to the pointing-based input 385C of FIG. 3C, and as also illustrated in FIG. 3D, an additional first pane response 381D is rendered in the first pane 380 and supplants the previously rendered initial first pane response 381B. The additional first pane response 381D is generated based on the pointing-based interaction 385C of FIG. 3C and includes three resolution portions 381D1, 381D2, and 381D3, that present resolutions to a conflict caused by the pointing-based interaction 385C of FIG. 3C. As also illustrated in FIG. 3D, a pointing-based interaction 385D is provided with the resolution portion 381D3, indicating a user selection of the resolution corresponding to resolution portion 381D3.

In response to the pointing-based input 385D of FIG. 3D, the “duration” interactive graphical element, of section 394D (FIG. 3D) of the second pane response is updated, as reflected in FIG. 3E, to be “1½ hrs” as opposed to “2 hrs”. Further, a further first pane response 381E is rendered in the first pane 380 and is one generated based on the pointing-based interaction 385D of FIG. 3D and reflects the pointing-based interaction 385D of FIG. 3D.

FIG. 3F illustrates natural language input 361F, of a user, that is directed to the first pane 380 of the GUI 300 and a yet further first pane response 381F that is generated based on the natural language input 361F. The first pane response 381F includes prompts 381E1, 381E2, and 381E3. A pointing-based interaction 385F is also illustrated in FIG. 3F, and is directed to the prompt 381E2, indicating a selection of the prompt 381E2.

In response to the pointing-based input 385F of FIG. 3F, the “Eiffel Tower” section 395B (FIGS. 3B-3F) of the second pane response is replaced, as reflected in FIG. 3G, with a new “Arc de Triomphe” section 395G. Further, a further first pane response 381G is rendered in the first pane 380 and is one generated based on the pointing-based interaction 385F of FIG. 3F and reflects the replacement of the “Eiffel Tower” section 395B of the second pane response with the new “Arc de Triomphe” section 395G.

FIG. 3H illustrates a pointing-based interaction 385H with a time graphical interface element of section 393B of the yet further updated second pane response, as updated in FIG. 3G. The pointing-based interaction 385H selects an alternate local time constraint of “10:30” for “check-in” in lieu of the initial “12:00” local time constraint of the initial section 393B. Accordingly, the pointing-based interaction 385H updates the state of the time interactive graphical element of section 393B from “12:00” to “10:30” as illustrated in FIG. 3I by updated section 3931.

In response to the pointing-based input 385H of FIG. 3H, and as also illustrated in FIG. 3I, an additional first pane response 3811 is rendered in the first pane 380 and supplants the previously rendered first pane response 381G. The additional first pane response 3811 is generated based on the pointing-based interaction 385H of FIG. 3H and reflects that section 3931 has also been updated to reflect alternative hotel options that are likely to accommodate the earlier 10:30 am check-in indicated by the pointing-based interaction 385H. The update to the second response that is reflected in the section 3931 and that presents the alternative hotel options, is also generated based on the pointing-based interaction 385H of FIG. 3H.

FIG. 3J illustrates a pointing-based interaction 385J with another graphical interface element of the section 3931. Namely, a pointing-based interaction 385J that selects one of the hotels (“#5 Motel”). As reflected in FIG. 3K, the pointing-based interaction 385J results in updating of the second pane response (as reflected by section 393K). However, notably it does not result in any additional first pane response.

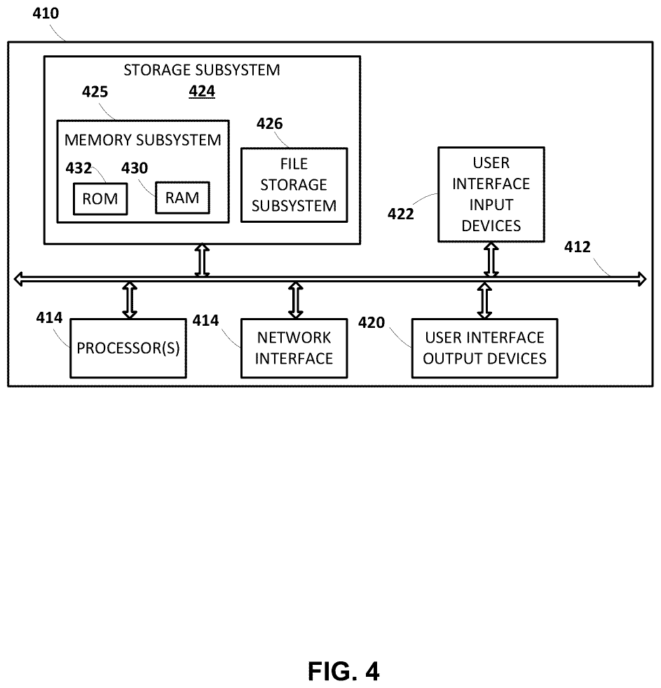

Turning now to FIG. 4, a block diagram of an example computing device 410 that may optionally be utilized to perform one or more aspects of techniques described herein is depicted. In some implementations, one or more of a client device, cloud-based automated assistant component(s), and/or other component(s) may comprise one or more components of the example computing device 410.

Computing device 410 typically includes at least one processor 414 which communicates with a number of peripheral devices via bus subsystem 412. These peripheral devices may include a storage subsystem 424, including, for example, a memory subsystem 625 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some, or all, of the modules described herein. For example, the storage subsystem 424 may include the logic to perform selected aspects of the methods disclosed herein, as well as to implement various components depicted in FIG. 1.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem 412 may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations a method implemented by processor(s) is provided and includes receiving an input query that is generated based on user interface input at a client device. The method further includes processing the input query, using at least one of one or more generative models, to generate both a first pane response and a second pane response. The second pane response differs from the first pane response and wherein the second pane response includes a plurality of interactive graphical elements that are modifiable through pointing-based interaction. The method further includes causing the first pane response to be rendered in a first pane of a graphical user interface. The method further includes causing the second pane response to be rendered in a second pane of the graphical user interface along with rendering of the first pane response in the first pane of the graphical user interface. The method further includes, during rendering of the first pane and the second pane of the graphical user interface, monitoring for occurrence of natural language input that is directed to the first pane and also monitoring for occurrence of pointing-based input that is directed to the second pane and that modifies one or more of the interactive graphical elements. The method further includes, in response to detecting, during the monitoring, an instance of natural language input directed to the first pane: processing the instance of natural language input and a representation of the second pane response, using one or more of the generative models, to generate both an additional first pane response and an update to the second pane response; and causing the additional first pane response to be rendered in the first pane and causing the second pane response to be updated in accordance with the update to the second pane response. The method further includes, in response to detecting, during the monitoring and while the second pane response, as updated, is rendered in the second pane, an instance of pointing-based input that is directed to the second pane response and that modifies one or more states, of the second pane response as updated, to one or more updated states: causing the updated second pane response to be further updated to visually reflect the one or more updated states; processing the one or more updated states and the representation of the second pane response, using one or more of the generative models, to generate an additional first pane response; and causing the further first pane response to be rendered in the first pane.

These and other implementations disclosed herein can include one or more of the following features.

In some implementations, processing the one or more updated states and the representation of the second pane response, using one or more of the generative models, to generate the additional first pane response includes: processing the one or more updated states and the representation of the second pane response, using one or more of the generative models, to generate generative model output; and determining, based on the generative model output, whether to provide the further first pane response. In some of those implementations, determining whether to provide the further first pane response is based on the generative model output characterizing the further first pane response in lieu of characterizing instructions to suppress providing of any further first pane response.

In some implementations, the further first pane response includes a conflict portion that includes natural language characterizing a conflict created by the one or more updated states and includes a resolution portion that includes natural language characterizing a candidate resolution to the conflict. In some of those implementations, the resolution portion is selectable and the method further includes, in response to a user selection of the resolution portion, causing the second pane response to be further updated in accordance with the candidate resolution to the conflict.

In some implementations, the method further includes causing to be rendered, in the first pane of the graphical user interface and along with the first pane response, a natural language input element. In some of those implementations, detecting the instance of the natural language input directed to the first pane includes detecting the instance of the natural language input based on typed input or spoken input and based on the typed input or the spoken input occurring following a pointing-based interaction with the natural language input element rendered in the first pane.

In some implementations, the one or more states that are modified by the pointing-based input include: a local temporal condition for one or more elements of the second pane response, a global temporal condition for all elements of the second pane response, and/or a selection condition that indicates whether an element of the second pane response is currently selected.

In some implementations, the user interface input is received via interaction with the graphical user interface and when the input query is received the graphical user interface lacks the first pane and the second pane. In some versions of those implementations, the method further includes, prior to processing the input query to generate both the first pane response and the second pane response, initially processing the input query to determine, based on the initial processing, that the input query is a candidate for dynamic multi-pane interaction. In those versions, processing the input query to generate both the first pane response and the second pane response is contingent on determining that the input query is a candidate for dynamic multi-pane interaction. In some of those versions, the method further includes, prior to processing the input query to generate both the first pane response and the second pane response, and in response to determining that the input query is a candidate for dynamic multi-pane interaction: causing a prompt to be provided, via the graphical interface, wherein the prompt requests affirmation that dynamic multi-pane interaction is desirable; and receiving affirmative user interface input responsive to the prompt. In such versions, processing the input query to generate both the first pane response and the second pane response is in response to receiving the affirmative user interface input responsive to the prompt.

In some implementations, the input query includes natural language content that is based on the user interface input and/or includes an image that is specified by the user interface input. In some versions of those implementations, the input query further includes contextual information associated with the user interface input. In some of those versions, the contextual information includes location information characterizing a location of a client device via which the user interface input is provided, file information characterizing one or more files locally stored at the client device, and/or application information characterizing content from one or more applications of the client device.

In some implementations, processing the input query, using at least one of the one or more generative models, to generate the second pane response includes: processing, using one or more of the generative models, a first prompt that includes the input query to generate first generative output; determining, based on the first generative output, an intent reflected by the input query, a plurality of entities for the intent, and a plurality of constraints; processing, using one or more of the generative models, a second prompt that includes one or more example graphical interface schemas, the intent, the plurality of entities, and the plurality of constraints, to generate second generative output; determining, based on the second generative output, a particular graphical interface schema and a correlation of particular entities, of the entities, to the graphical interface schema; and generating the second pane response based on the graphical interface schema and the correlation of the particular entities to the graphical interface schema. In some versions of those implementations, determining, based on the first generative output, the plurality of entities for the intent includes: determining, based on the first generative output, entity parameters; transmitting, via one or more application programming interfaces and to an external system, a request that is generated based on the entity parameters; and receiving, from the external system responsive to the request, the plurality of the entities. For example, the plurality of entities, received from the external system, can include a business location entity that specifies a name of the business location, a location of the business location, and operating hours for the business location. In some additional or alternative versions of those implementations, the method further includes: receiving, with the input query, an indication of a user account; searching, based on one or more terms of the input query, one or more corpuses for the user account; determining, based on the searching, one or more responsive information items from the one or more corpuses; and including content from the responsive information items in the first prompt that is processed in generating the first generative output. In some further additional or further alternative versions of those implementations, the method further includes: determining, based on the first generative output, the first response, where causing the first pane response to be rendered in the first pane of the graphical user interface comprises causing the first pane response to be rendered prior to generating the second pane response.

In some implementations, the first pane is rendered, in the graphical user interface, to the left of the second pane and/or a first area occupied by the first pane is at least fifty percent smaller than a second area occupied by the second pane.

In some implementations a method implemented by processor(s) is provided and includes receiving an input query that is generated based on user interface input at a client device. The method further includes processing the input query, using at least one of one or more generative models, to generate both a first pane response and a second pane response. The second pane response differs from the first pane response and wherein the second pane response includes a plurality of interactive graphical elements that are modifiable through pointing-based interaction. The method further includes causing the first pane response to be rendered in a first pane of a graphical user interface and causing the second pane response to be rendered in a second pane of the graphical user interface along with rendering of the first pane response in the first pane of the graphical user interface. The method further includes, while rendering the graphical user interface, monitoring for occurrence of natural language input that is directed to the first pane and also monitoring for occurrence of pointing-based input that is directed to the second pane and that modifies one or more states of one or more of the interactive graphical elements. The method further includes in response to detecting, during the monitoring, an instance of pointing-based input that is directed to the second pane and that modifies one or more states, of one or more of the interactive graphical elements, to one or more updated states: causing the second pane response to be updated, including causing one or more of the interactive graphical elements to visually reflect the one or more updated states; processing a representation of the second pane response including the one or more updated states, using one or more of the generative models, to generate an additional first pane response; and causing the additional first pane response to be rendered in the first pane. The method further includes in response to detecting, during the monitoring and subsequent to the additional first pane response being rendered, an instance of natural language input directed to the first pane: processing the instance of natural language input and a current representation of the second pane response at a time of the instance of natural language input, using one or more of the generative models, to generate both a further first pane response and an update to the second pane response; and causing the additional first pane response to be rendered in the first pane and causing the second pane response to be further updated in accordance with the generated update to the second pane response.

In some implementations a method implemented by processor(s) is provided and includes receiving an input query that is generated based on user interface input at a client device. The method further includes processing the input query, using at least one of one or more generative models, to generate both a first pane response and a second pane response. The second pane response differs from the first pane response and the second pane response includes a plurality of interactive graphical elements that are modifiable through pointing-based interaction. Processing the input query, using at least one of the one or more generative models, to generate the second pane response includes: processing, using one or more of the generative models, a first prompt that includes the input query to generate first generative output; determining, based on the first generative output, an intent reflected by the input query, a plurality of entities for the intent, and a plurality of constraints; processing, using one or more of the generative models, a second prompt that includes the intent, the plurality of entities, and the plurality of constraints, to generate second generative output; determining, based on the second generative output, a particular graphical interface schema and a correlation of particular entities, of the entities, to the graphical interface schema; and generating the second pane response based on the graphical interface schema and the correlation of the particular entities to the graphical interface schema. The method further includes causing the first pane response to be rendered in a first pane of a graphical user interface and causing the second pane response to be rendered in a second pane of the graphical user interface along with rendering of the first pane response in the first pane of the graphical user interface. The method further includes, while rendering the graphical user interface, monitoring for occurrence of natural language input that is directed to the first pane and also monitoring for occurrence of pointing-based input that is directed to the second pane and that modifies one or more states of one or more of the interactive graphical elements.

These and other implementations disclosed herein can include one or more of the following features.

In some implementations, the second prompt further includes one or more example graphical interface schemas.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving an input query that is generated based on user interface input at a client device;
processing the input query, using at least one of one or more generative models, to generate both a first pane response and a second pane response,
wherein the second pane response differs from the first pane response and wherein the second pane response includes a plurality of interactive graphical elements that are modifiable through pointing-based interaction;
causing the first pane response to be rendered in a first pane of a graphical user interface;
causing the second pane response to be rendered in a second pane of the graphical user interface along with rendering of the first pane response in the first pane of the graphical user interface;
during rendering of the first pane and the second pane of the graphical user interface:
monitoring for occurrence of natural language input that is directed to the first pane and also monitoring for occurrence of pointing-based input that is directed to the second pane and that modifies one or more of the interactive graphical elements;
in response to detecting, during the monitoring, an instance of natural language input directed to the first pane:
processing the instance of natural language input and a representation of the second pane response, using one or more of the generative models, to generate both an additional first pane response and an update to the second pane response; and
causing the additional first pane response to be rendered in the first pane and causing the second pane response to be updated in accordance with the update to the second pane response;
in response to detecting, during the monitoring and while the second pane response, as updated, is rendered in the second pane, an instance of pointing-based input that is directed to the second pane response and that modifies one or more states, of the second pane response as updated, to one or more updated states:
causing the updated second pane response to be further updated to visually reflect the one or more updated states;
processing the one or more updated states and the representation of the second pane response, using one or more of the generative models, to generate an additional first pane response; and
causing the further first pane response to be rendered in the first pane.

2. The method of claim 1, wherein processing the one or more updated states and the representation of the second pane response, using one or more of the generative models, to generate the additional first pane response comprises:
processing the one or more updated states and the representation of the second pane response, using one or more of the generative models, to generate generative model output;
determining, based on the generative model output, whether to provide the further first pane response;
wherein determining whether to provide the further first pane response is based on the generative model output characterizing the further first pane response in lieu of characterizing instructions to suppress providing of any further first pane response.

3. The method of claim 1, wherein the further first pane response includes:
a conflict portion that includes natural language characterizing a conflict created by the one or more updated states; and
a resolution portion that includes natural language characterizing a candidate resolution to the conflict.

4. The method of claim 3, wherein the resolution portion is selectable and further comprising:
in response to a user selection of the resolution portion:
causing the second pane response to be further updated in accordance with the candidate resolution to the conflict.

5. The method of claim 1, further comprising:
causing to be rendered, in the first pane of the graphical user interface and along with the first pane response, a natural language input element;
wherein detecting the instance of the natural language input directed to the first pane comprises detecting the instance of the natural language input based on typed input or spoken input and based on the typed input or the spoken input occurring following a pointing-based interaction with the natural language input element rendered in the first pane.

6. The method of claim 1, wherein the one or more states that are modified by the pointing-based input include:
a local temporal condition for one or more elements of the second pane response,
a global temporal condition for all elements of the second pane response, and/or
a selection condition that indicates whether an element of the second pane response is currently selected.

7. The method of claim 1, wherein the user interface input is received via interaction with the graphical user interface and when the input query is received the graphical user interface lacks the first pane and the second pane.

8. The method of claim 7, further comprising:
prior to processing the input query to generate both the first pane response and the second pane response:
initially processing the input query to determine, based on the initial processing, that the input query is a candidate for dynamic multi-pane interaction;
wherein processing the input query to generate both the first pane response and the second pane response is contingent on determining that the input query is a candidate for dynamic multi-pane interaction.

9. The method of claim 8, further comprising:
prior to processing the input query to generate both the first pane response and the second pane response, and in response to determining that the input query is a candidate for dynamic multi-pane interaction:
causing a prompt to be provided, via the graphical interface, wherein the prompt requests affirmation that dynamic multi-pane interaction is desirable; and
receiving affirmative user interface input responsive to the prompt;
wherein processing the input query to generate both the first pane response and the second pane response is in response to receiving the affirmative user interface input responsive to the prompt.

10. The method of claim 1, wherein the input query includes natural language content that is based on the user interface input and/or includes an image that is specified by the user interface input.

11. The method of claim 10, wherein the input query further includes contextual information associated with the user interface input.

12. The method of claim 11, wherein the contextual information includes location information characterizing a location of a client device via which the user interface input is provided, file information characterizing one or more files locally stored at the client device, and/or application information characterizing content from one or more applications of the client device.

13. The method of claim 1, wherein processing the input query, using at least one of the one or more generative models, to generate the second pane response comprises:
processing, using one or more of the generative models, a first prompt that includes the input query to generate first generative output;
determining, based on the first generative output, an intent reflected by the input query, a plurality of entities for the intent, and a plurality of constraints;
processing, using one or more of the generative models, a second prompt that includes one or more example graphical interface schemas, the intent, the plurality of entities, and the plurality of constraints, to generate second generative output;
determining, based on the second generative output, a particular graphical interface schema and a correlation of particular entities, of the entities, to the graphical interface schema; and
generating the second pane response based on the graphical interface schema and the correlation of the particular entities to the graphical interface schema.

14. The method of claim 13, wherein determining, based on the first generative output, the plurality of entities for the intent comprises:
determining, based on the first generative output, entity parameters;
transmitting, via one or more application programming interfaces and to an external system, a request that is generated based on the entity parameters; and
receiving, from the external system responsive to the request, the plurality of the entities.

15. The method of claim 14, wherein the plurality of entities, received from the external system, include a business location entity that specifies a name of the business location, a location of the business location, and operating hours for the business location.

16. The method of claim 13, further comprising:
receiving, with the input query, an indication of a user account;
searching, based on one or more terms of the input query, one or more corpuses for the user account;
determining, based on the searching, one or more responsive information items from the one or more corpuses; and
including content from the responsive information items in the first prompt that is processed in generating the first generative output.

17. The method of claim 13, further comprising:
determining, based on the first generative output, the first response;
wherein causing the first pane response to be rendered in the first pane of the graphical user interface comprises causing the first pane response to be rendered prior to generating the second pane response.

18. A method implemented by one or more processors, the method comprising:
receiving an input query that is generated based on user interface input at a client device;
processing the input query, using at least one of one or more generative models, to generate both a first pane response and a second pane response,
wherein the second pane response differs from the first pane response and wherein the second pane response includes a plurality of interactive graphical elements that are modifiable through pointing-based interaction;
causing the first pane response to be rendered in a first pane of a graphical user interface;
causing the second pane response to be rendered in a second pane of the graphical user interface along with rendering of the first pane response in the first pane of the graphical user interface;
while rendering the graphical user interface:
monitoring for occurrence of natural language input that is directed to the first pane and also monitoring for occurrence of pointing-based input that is directed to the second pane and that modifies one or more states of one or more of the interactive graphical elements;
in response to detecting, during the monitoring, an instance of pointing-based input that is directed to the second pane and that modifies one or more states, of one or more of the interactive graphical elements, to one or more updated states:
causing the second pane response to be updated, including causing one or more of the interactive graphical elements to visually reflect the one or more updated states;
processing a representation of the second pane response including the one or more updated states, using one or more of the generative models, to generate an additional first pane response; and
causing the additional first pane response to be rendered in the first pane;
in response to detecting, during the monitoring and subsequent to the additional first pane response being rendered, an instance of natural language input directed to the first pane:
processing the instance of natural language input and a current representation of the second pane response at a time of the instance of natural language input, using one or more of the generative models, to generate both a further first pane response and an update to the second pane response; and
causing the additional first pane response to be rendered in the first pane and causing the second pane response to be further updated in accordance with the generated update to the second pane response.

19. The method of claim 18, wherein processing the one or more updated states and the representation of the second pane response, using one or more of the generative models, to generate the additional first pane response comprises:
processing the one or more updated states and the representation of the second pane response, using one or more of the generative models, to generate generative model output;
determining, based on the generative model output, whether to provide the further first pane response;
wherein determining whether to provide the further first pane response is based on the generative model output characterizing the further first pane response in lieu of characterizing instructions to suppress providing of any further first pane response.

20. A method implemented by one or more processors, the method comprising:
receiving an input query that is generated based on user interface input at a client device;
processing the input query, using at least one of one or more generative models, to generate both a first pane response and a second pane response,
wherein the second pane response differs from the first pane response and wherein the second pane response includes a plurality of interactive graphical elements that are modifiable through pointing-based interaction, and
wherein processing the input query, using at least one of the one or more generative models, to generate the second pane response comprises:
processing, using one or more of the generative models, a first prompt that includes the input query to generate first generative output;
determining, based on the first generative output, an intent reflected by the input query, a plurality of entities for the intent, and a plurality of constraints;
processing, using one or more of the generative models, a second prompt that includes the intent, the plurality of entities, and the plurality of constraints, to generate second generative output;
determining, based on the second generative output, a particular graphical interface schema and a correlation of particular entities, of the entities, to the graphical interface schema; and
generating the second pane response based on the graphical interface schema and the correlation of the particular entities to the graphical interface schema;
causing the first pane response to be rendered in a first pane of a graphical user interface;
causing the second pane response to be rendered in a second pane of the graphical user interface along with rendering of the first pane response in the first pane of the graphical user interface; and
while rendering the graphical user interface:
monitoring for occurrence of natural language input that is directed to the first pane and also monitoring for occurrence of pointing-based input that is directed to the second pane and that modifies one or more states of one or more of the interactive graphical elements.
